(19) United States
(12) Patent Application Publication
(10) Pub. No.: US 2022/0013931 A1
(43) Pub. Date: Jan. 13, 2022

(54) WIRE HARNESS

(71) Applicant: Yazaki Corporation, Tokyo (JP)

(72) Inventor: Shinya MATSUURA, Makinohara-shi (JP)

(73) Assignee: Yazaki Corporation, Tokyo (JP)

(21) Appl. No.: 17/355,367

(22) Filed: Jun. 23, 2021

(30) Foreign Application Priority Data
Jul. 13, 2020 (JP) 2020-120110

(51) Int. Cl. H01R 4/70; H01R 13/52

(52) U.S. Cl. CPC H01R 4/70; H01R 4/183; H01R 13/5205

(57) ABSTRACT

A wire harness to be wired in a vehicle includes an electric wire including a core wire constituted of strands and a sheath covering the core wire, a first terminal connected to one end portion of the electric wire located on one side of the electric wire, a first housing accommodating the first terminal, a second terminal connected to another end portion of the electric wire located on another side of the electric wire, a second housing accommodating the second terminal, a rubber stopper fitted onto the electric wire to close a gap between the electric wire and the first housing, a sealing portion that fills spaces between the strands at the one end portion to prevent water from entering the one side, and a corrosion protection portion covering an exposed portion of the core wire with the core wire connected to the second terminal at the another end portion.

### TECHNICAL FIELD

The present invention relates to a wire harness.

### BACKGROUND

Vehicles are equipped with a wide variety of electronic devices, and wire harnesses are wired to transmit power, control signals, etc. to the electronic devices. In some cases, aluminum is used as a material of a conductor core wire of an electric wire constituting the wire harness (for example, refer to Patent Document 1).

Patent Document 1 discloses an electric wire with terminal that includes an aluminum electric wire (hereinafter, referred to as an electric wire) including a conductor core wire made of aluminum and a terminal connected to one end of the electric wire. A terminal fitting includes a core wire crimping portion to be connected by crimp connection to the core wire of the electric wire, a sheath fixing portion provided around a sheath of the electric wire with a gap from the sheath, and a connection portion provided between the core wire crimping portion and the sheath fixing portion. Further, in a state where the terminal fitting is connected to the electric wire, the exposed portion of the core wire, the connection portion, the sheath fixing portion, and an end portion of the sheath are covered with resin, and the gap between the sheath of the electric wire and the sheath fixing portion of the terminal is filled with resin.

When producing the electric wire with terminal, a first resin is applied to the exposed portion of the core wire and cured. Then, a second resin is applied so as to cover the core wire crimping portion, the connection portion, the sheath fixing portion and the sheath of the electric wire. Then, a preset period of time is elapsed, in which the second resin penetrates between strands constituting the core wire and in the gap between the sheath of the electric wire and the sheath fixing portion of the terminal. Then, the second resin is cured. In this manner, the electric wire with terminal is produced.

### PRIOR ART DOCUMENT

Patent Document 1: JP 2019-129067 A

### SUMMARY OF THE INVENTION

### Problem to be Solved by the Invention

However, at each of the end portions of the conventional electric wire with terminal, the exposed portion of the core wire and the sheath are covered with resin, and the resin is also provided to fill spaces between the strands constituting the core wire. When producing such electric wire with terminal, it is necessary to apply the resin twice to each of the end portions, causing poor production efficiency.

In view of this, an object of the present invention is to provide a wire harness with improved production efficiency.

### Solution to the Problem

In order to achieve the above-described object, the present invention provides, in a first aspect, a wire harness to be wired in a vehicle, including an electric wire including a core wire constituted of a plurality of strands and a sheath covering the core wire, a first terminal connected to one end portion of the electric wire, the one end portion being located on one side of the electric wire, a first housing that accommodates the first terminal, a second terminal connected to another end portion of the electric wire, the another end portion being located on another side of the electric wire, a second housing that accommodates the second terminal, a rubber stopper fitted onto the electric wire so as to close a gap between the electric wire and the first housing, a sealing portion provided so as to fill spaces between the plurality of strands at the one end portion so as to prevent water from entering the one side, and a corrosion protection portion that covers an exposed portion of the core wire in a state where the core wire and the second terminal are connected to each other at the another end portion.

In a second aspect of the present invention, the plurality of strands constituting the electric wire includes aluminum.

In a third aspect of the present invention, the first terminal is configured to be connected to a first device installed in an engine compartment of the vehicle, and the second terminal is configured to be connected to a second device installed in a region other than the engine compartment, the region being partitioned from the engine compartment.

### Advantageous Effect of the Invention

According to the first aspect of the present invention, a wire harness to be wired in a vehicle includes the first terminal connected to the one end portion of the electric wire, the first housing that accommodates the first terminal, the second terminal connected to the another end portion of the electric wire, the second housing that accommodates the second terminal, the rubber stopper fitted onto the electric wire so as to close the gap between the electric wire and the first housing, the sealing portion that fills spaces between the plurality of strands at the one end portion so as to prevent water from entering the one side, and the corrosion protection portion that covers the exposed portion of the core wire in the state where the core wire and the second terminal are connected to each other at the another end portion. Thus, when the first terminal connected to the one end portion of the electric wires is installed in an environment such as in an engine compartment or the like in the vehicle that is configured to be cooled rapidly, if a negative pressure is generated due to the cooling, the sealing portion prevents water from entering the one side because the sealing portion is provided to fill the spaces between the plurality of strands at the one end portion of the electric wire so as to prevent water from entering the one side. That is, there is no need to provide resin between the strands constituting the core wire at both of the end portions of the electric wire as in the case in the conventional art, and water can be prevented from entering the one side by sealing only the one end portion with the sealing portion, thus it is possible to omit an operation of providing resin between the strands constituting the core wire for the another end portion. Consequently, the operation of providing the sealing portion at the one end portion and the operation of providing the corrosion protection portion at the another end portion can be performed at the same time, thereby improving production efficiency compared to the conventional art in which resin is applied twice to each of the end portions.

### BRIEF DESCRIPTION OF THE DRAWINGS

FIG. 1 is a cross sectional view showing a first connector of a wire harness according to one embodiment of the present invention;

FIG. 2 is a cross sectional view showing a second connector of the wire harness; and

FIG. 3 is a schematic conceptual diagram for explaining an effect provided by one embodiment of the present invention.

### DETAILED DESCRIPTION OF THE EXEMPLARY EMBODIMENTS

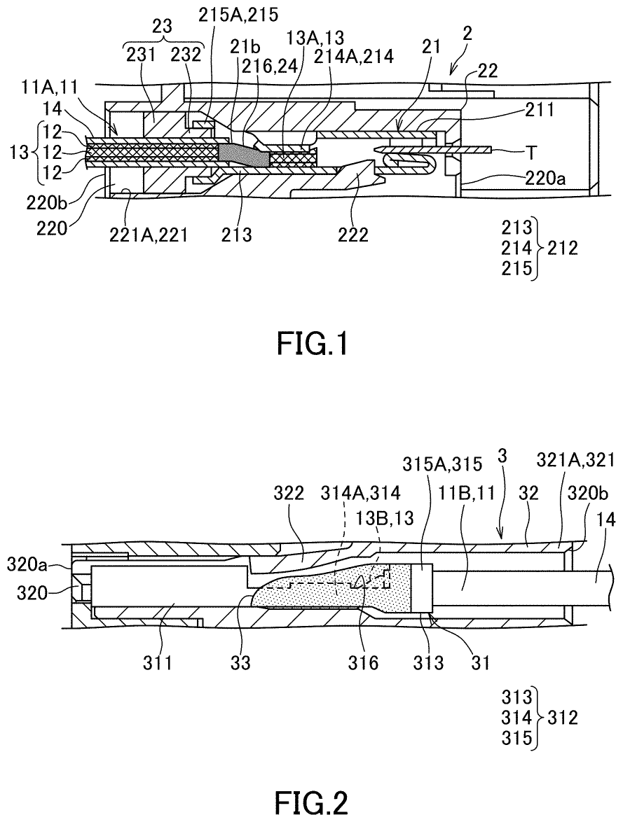

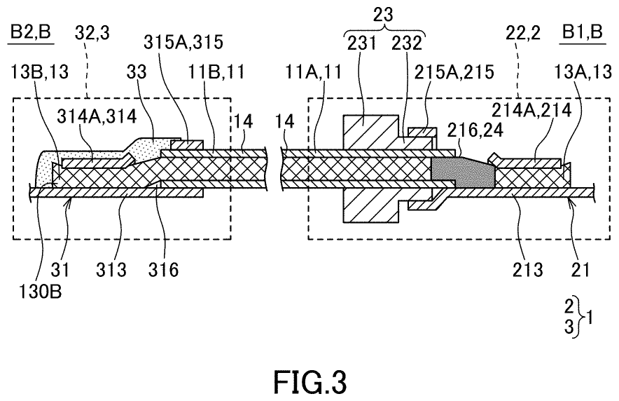

One embodiment of the present invention will be described with reference to FIG. 1 to FIG. 3. FIG. 1 is a cross-sectional view showing a first connector 2 of a wire harness 1 according to one embodiment of the present invention. FIG. 2 is a cross-sectional view showing a second connector 3 of the wire harness 1. FIG. 3 is a schematic diagram for explaining an effect provided by the wire harness 1. As shown in FIG. 3, the wire harness 1 is configured to be connected between an electrical component (second device) not shown installed in a vehicle interior B2 of a vehicle B and an electronic control unit (ECU) (first device) not shown for performing control of each electrical component and such to transmit a control signal from the electronic control unit to each electrical component. That is, the first connector 2 constituting the wire harness 1 is connected to the electronic control unit, and the second connector 3 is connected to the electrical component. In this embodiment, the electronic control unit is installed in an engine compartment B1, and the electrical component is installed in the vehicle interior B2 partitioned from the engine compartment B1.

As shown in FIG. 1 and FIG. 2, the wire harness 1 includes a covered electric wire 11 (hereinafter referred to as the electric wire 11), the first connector 2 (shown in FIG. 1) connected to one end portion 11A of the electric wire 11, the one end portion being located on one side of the electric wire 11, and the second connector 3 (shown in FIG. 2) connected to another end portion 11B of the electric wire 11, the another end portion 11B being located on another side of the electric wire 11.

As shown in FIG. 1, the electric wire 11 includes a core wire 13 which is a collection of wire-like strands 12 having electrical conductivity, and a sheath 14 covering the core wire 13 in an insulating manner. The strands 12 include aluminum. In other words, the electric wire 11 is an aluminum wire 11 or an aluminum alloy wire 11. At each of the end portions 11A, 11B, the sheath 14 of the electric wire 11 is peeled off, and thereby a part of the core wire 13 (hereinafter, it may be referred to as a core wire exposed portion 13A, 13B) is exposed. In this embodiment, with respect to an extending direction of the electric wire 11, a side at which the core wire exposed portion 13A, 13B is provided may be referred to as “distal end side”, and a side at which the sheath 14 is provided may be referred to as “proximal end side”.

As shown in FIG. 1, the first connector 2 is constituted of a waterproof connector including a first terminal 21 connected to the one end portion 11A of the electric wire 11, a first housing 22, a rubber stopper 23 and a sealing portion 24.

The first terminal 21 is constituted of copper or a copper alloy. As shown in FIG. 1 and FIG. 3, the first terminal 21 includes a first mating connection portion 211 (shown in FIG. 1) configured to be connected to a first mating terminal T, and a first electric wire connection portion 212 which is continuous with the first mating connection portion 211 and which is connected to the one end portion 11A of the electric wire 11. In FIG. 3, the first mating connection portion 211 is not shown.

The first electric wire connection portion 212 includes a first placement portion 213 on which the one end portion 11A of the electric wire 11 is placed, a first electrical connection portion 214 which is continuous with the first placement portion 213 and which is electrically connected to the core wire exposed portion 13A of the electric wire 11, and a first mechanical connection portion 215 which is continuous with the first placement portion 213 and which is mechanically connected to the sheath 14 of the electric wire 11 via the rubber stopper 23 described later. The first mechanical connection portion 215 is provided at a position spaced apart by a predetermined dimension from the first electrical connection portion 214 to the proximal end side. In the following, the spaced portion between the first mechanical connection portion 215 and the first electrical connection portion 214 may be referred to as “first intermediate portion 216”.

The first electrical connection portion 214 is located between the first mating connection portion 211 and the first intermediate portion 216. The first electrical connection portion 214 includes a pair of first core wire crimp pieces 214A, 214A which extends from the first placement portion 213 and which is connected by crimp connection to the core wire exposed portion 13A of the electric wire 11. The first mechanical connection portion 215 includes a pair of the first rubber stopper crimp pieces 215A, 215A which extends from the first placement portion 213 and which is connected by crimp connection to the rubber stopper 23 fitted onto the one end portion 11A of the electric wire 11.

The first housing 22 is formed by four peripheral walls 221 constituting a terminal accommodation chamber 220 into which the first terminal 21 is inserted and accommodated. The terminal accommodation chamber 220 includes openings 220a, 220b that are respectively arranged on a side in an insertion direction of the first terminal 21 (i.e., the distal end side) and an opposite side in the insertion direction (i.e., the proximal end side). The first mating terminal T to be connected to the first terminal 21 is inserted from the opening 220a on the distal end side, and the rubber stopper 23 is press-fitted from the opening 220b on the proximal end side. Further, one peripheral wall 221A of the four peripheral walls 221 (i.e., the one on the lower side in FIG. 1) is provided with a lance 222 that is formed to extend in the insertion direction and that is configured to lock the first terminal 21.

The rubber stopper 23 is formed in a shape of a tube capable of being fitted onto the sheath 14 of the electric wire 11. The rubber stopper 23 includes a stopper large diameter portion 231 having an outer diameter dimension capable of being press-fitted into the terminal accommodation chamber 220, and a stopper small diameter portion 232 to which the pair of first rubber stopper crimp pieces 215A, 215A of the first terminal 21 is connected. The rubber stopper 23 is configured such that, while it is fitted onto the sheath 14 of the electric wire 11, the stopper large diameter portion 231 is press-fitted into the terminal accommodation chamber 220 to close the gap between the electric wire 11 and the terminal accommodation chamber 220 (the first housing) so as to prevent water from entering the distal end side.

The sealing portion 24 is formed by placing the core wire exposed portion 13A of the one end portion 11A of the electric wire 11 on the first placement portion 213, connecting by crimp connection the pair of first core wire crimp pieces 214A, 214A to the core wire exposed portion 13A, and, in this state, providing molten resin to fill spaces between the plurality of strands 12 and curing the resin, thus the sealing portion 24 is configured to prevent water from entering the distal end side (i.e., the one side). In this embodiment, the sealing portion 24 is provided so as to include a part of the core wire exposed portion 13A that corresponds to the first intermediate portion 216 of the first terminal 21, and inside the sheath 14 of the electric wire 11 is also filled with the sealing portion 24, thereby preventing water from entering the distal end side (i.e., the one side).

In the following, a procedure for producing the first connector 2 described above is explained. Firstly, the core wire exposed portion 13A is formed in advance by peeling off the sheath 14 at the one end portion 11A of the electric wire 11. Next, at the one end portion 11A of the electric wire 11, the stopper large diameter portion 231 of the rubber stopper 23 is moved close to a distal end of the electric wire 11 and is press-fitted onto the one end portion 11A. Thus, the rubber stopper 23 is fitted onto the one end portion 11A of the electric wire 11 in an orientation in which the stopper large diameter portion 231 is arranged at the proximal end side and the stopper small diameter portion 232 is arranged at the distal end side. Subsequently, the one end portion 11A of the electric wire 11 is placed onto the first placement portion 213 of the first terminal 21, and the pair of first core wire crimp pieces 214A, 214A is connected by crimp connection to the core wire exposed portion 13A of the electric wire 11, and the pair of first rubber stopper crimp pieces 215A, 215A is connected by crimp connection to the rubber stopper 23 fitted onto the sheath 14 of the electric wire 11. In this manner, the first electrical connection portion 214 is electrically connected to the one end portion 11A of the electric wire 11, and the first mechanical connection portion 215 is mechanically connected to the one end portion 11A of the electric wire 11, thereby the first terminal 21 is connected to the one end portion 11A of the electric wire 11. Thereafter, molten resin is injected to the first intermediate portion 216 to fill spaces between the plurality of strands 12 in the core wire exposed portion 13A of one end portion 11A of the electric wire 11, followed by curing the resin. Thus, the molten resin is provided so as to include the part of the core wire exposed portion 13A that corresponds to the first intermediate portion 216 of the first terminal 21, and inside the sheath 14 of the electric wire 11 is also filled with the molten resin, thereby forming the sealing portion 24 that prevents water from entering the distal end side (i.e., the one side). Finally, the first mating connection portion 211 of the first terminal 21 is moved close to and inserted into the opening 220b on the proximal end side of the terminal accommodation chamber 220. As it is inserted further, the stopper large diameter portion 231 of the rubber stopper 23 is press-fitted into the opening 220b of the proximal end side of the terminal accommodation chamber 220. As it is inserted further and when the first terminal 21 reaches to a predetermined position in the terminal accommodation chamber 220, the lance 222 locks the first terminal 21. In this manner, the first connector 2 as a waterproof connector is completed.

As shown in FIG. 2, the second connector 3 is constituted of a non-waterproof connector including a second terminal 31 connected to another end portion 11B of the electric wire 11, a second housing 32, and a corrosion protection portion 33.

The second terminal 31 is constituted of copper or a copper alloy. As shown in FIG. 2 and FIG. 3, the second terminal 31 includes a second mating connection portion 311 (shown in FIG. 2) configured to be connected to a second mating terminal not shown, and a second electric wire connection portion 312 which is continuous with the second mating connection portion 311 and which is connected to the another end portion 11B of the electric wire 11. In FIG. 3, the second mating connection portion 311 is not shown.

The second electric wire connection portion 312 includes a second placement portion 313 on which the another end portion 11B of the electric wire 11 is placed, a second electrical connection portion 314 which is continuous with the second placement portion 313 and which is electrically connected to the core wire exposed portion 13B (i.e., the exposed portion of the core wire) of the electric wire 11, and a second mechanical connection portion 315 which is continuous with the second placement portion 313 and which is mechanically connected to the sheath 14 of the electric wire 11. The second mechanical connection portion 315 is provided at a position spaced apart by a predetermined dimension from the second electrical connection portion 314 to the proximal end side. In the following, the spaced portion between the second mechanical connection portion 315 and the second electrical connection portion 314 may be referred to as “second intermediate portion 316”.

The second electrical connection 314 is located between the second mating connection portion 311 and the second intermediate portion 316. The second electrical connection portion 314 extends from the second placement portion 313 and includes a pair of second core wire crimp pieces 314A, 314A that is connected by crimp connection to the core wire exposed portion 13B of the electric wire 11. The second mechanical connection portion 315 extends from the second placement portion 313 and includes a pair of second sheath crimp pieces 315A, 315A that is connected by crimp connection to the sheath 14 of the another end portion 11B of the electric wire 11.

The second housing 32 is formed by four peripheral walls 321 constituting the terminal accommodation chamber 320 into which the second terminal 31 is inserted and accommodated. The terminal accommodation chamber 320 includes openings 320a, 320b that are respectively arranged on a side in the insertion direction of the second terminal 31 (i.e., the distal end side) and an opposite side in the insertion direction (i.e., the proximal end side), such that a second mating terminal (not shown) connected to the second terminal 31 is inserted from the opening 320a on the distal end side. Further, one peripheral wall 321A of the four peripheral walls 321 is provided with a lance 322 that is formed to extend in the insertion direction and that is configured to lock the second terminal 31.

The corrosion protection portion 33 is formed by placing the core wire exposed portion 13B of the another end portion 11B of the electric wire 11 on the second placement portion 313, connecting by the crimp connection the pair of second core wire crimp pieces 314A, 314A to the core wire exposed portion 13B, and, at this state, applying molten resin so as to cover the core wire exposed portion 13B and curing the resin, thus the corrosion protection portion 33 is configured to prevent corrosion of the core wire exposed portion 13B. In this embodiment, the corrosion protection portion 33 is formed by placing the core wire exposed portion 13B on the second placement portion 313, connecting by crimp connection the pair of second core wire crimp pieces 314A, 314A to the core wire exposed portion 13B, and, in this state, applying the molten resin so as to cover a part of the second terminal 31 that corresponds to the second intermediate portion 316, the second placement portion 313, the pair of second core wire crimp pieces 314A, 314A, and a protruding portion 130B (shown in FIG. 3) of the core wire exposed portion 13B that is located on the distal end side with respect to the pair of second core wire crimp pieces 314A, 314A, followed by curing the resin, and the corrosion protection portion 33 is configured to prevent corrosion of the core wire exposed portion 13B.

In the following, a procedure for producing the second connector 3 described above is explained. Firstly, the core wire exposed portion 13B is formed in advance by peeling off the sheath 14 at the another end portion 11B of the electric wire 11. Next, the another end portion 11B of the electric wire 11 is placed on the second placement portion 313 of the second terminal 31, and the pair of second core wire crimp pieces 314A, 314A is connected by crimp connection to the core wire exposed portion 13B of the electric wire 11 and the pair of second sheath crimp pieces 315A, 315A is connected by crimp connection to the sheath 14 of the electric wire 11. Thus, the second electrical connection portion 314 is electrically connected to the another end portion 11B of the electric wire 11, and the second mechanical connection portion 315 is mechanically connected to the another end portion 11B of the electric wire 11, thereby the second terminal 31 is connected to the another end portion 11B of the electric wire 11. Thereafter, the molten resin is applied so as to cover the core wire exposed portion 13B of the another end portion 11B of the electric wire 11 and cured. Thus, at the another end portion 11B of the electric wire 11, the part of the second terminal 31 that corresponds to the second intermediate portion 316, the second placement portion 313, the pair of second core wire crimp pieces 314A, 314A, and the protruding portion 130B (shown in FIG. 3) of the core wire exposed portion 13B that is located on the distal end side with respect to the pair of second core wire crimp pieces 314A, 314A, are covered by resin to prevent corrosion of the core wire exposed portion 13B. Finally, the second mating connection portion 311 of the second terminal 31 is moved close to and inserted to the opening 320b of the terminal accommodation chamber 320 on the proximal end side. When the second terminal 31 reaches to a predetermined position in the terminal accommodation chamber 320, the lance 322 locks the second terminal 31. In this manner, the second connector 3 as a non-waterproof connector is completed.

In the wire harness 1 having the configuration described above, the first connector 2 is connected to the electronic control unit installed in the engine compartment B1 and the second connector 3 is connected to the electrical component installed in the vehicle interior B2 to transmit an electric signal from the electronic control unit to the electrical component.

According to the embodiment described above, in a state where the first connector 2 is connected to the electronic control unit installed in the engine compartment B1 and the second connector 3 is connected to the electrical component installed in the vehicle interior B2 as shown in FIG. 3, when the engine compartment B1 is rapidly cooled and a negative pressure is generated due to the cooling, the sealing portion 24 prevents water from entering the one side because the sealing portion 24 is provided to fill spaces between the plurality of strands 12 at the one end portion 11A of the electric wire 11 to prevent water from entering the one side. That is, since water can be prevented from entering the one side by sealing only the one end portion 11A with the sealing portion 24, it is possible to omit an operation of providing resin between the strands 12 constituting the core wire 13 for the another end portion 11B. Consequently, the operation of providing the sealing portion 24 at the one end portion 11A and the operation of providing the corrosion protection portion 33 at the another end portion 11B can be performed at the same time, thereby improving production efficiency.

Further, it is possible to use existing components (conventional components) for the first terminal 21, the first housing 22 and the rubber stopper 23 constituting the first connector 2, and for the second terminal 31 and the second housing 32 constituting the second connector 3. In other words, the existing components can be used without using a dedicated housing that includes a space for accommodating resin material, thus an increase in manufacturing cost can be avoided.

Further, the electric wire 11 is constituted of the plurality of strands 12 including aluminum. Consequently, weight of the wire harness 1 can be reduced.

Further, the first connector 2 is connected to the electronic control unit (first device) installed in the engine compartment B1 of the vehicle B, and the second connector 3 is connected to the electrical component (second device) installed in the vehicle interior B2 (i.e., in a region other than the engine compartment B1 that is partitioned from the engine compartment B1). That is, the first terminal 21 is connected to the electronic control unit (first device) installed in the engine compartment B1 of the vehicle B, and the second terminal 31 is connected to the electrical component (second device) installed in the vehicle interior B2 (i.e., in the region other than the engine compartment B1 that is partitioned from the engine compartment B1). Thus, the wire harness 1 according to the embodiment described above can be used to connect electronic control unit in the engine compartment B1 and the electrical component in the vehicle interior B2. In the embodiment described above, the electrical component (second device) is installed in the vehicle interior B2 that is shown as an example of the region other than the engine compartment B1 partitioned from the engine compartment B1; however, the present invention is not limited to this. The region other than the engine compartment B1 may be, for example, a door panel, an underfloor panel, a luggage compartment or the like. That is, other arrangements are possible as long as the second connector is connected to the second device installed in the region partitioned from the engine compartment B1.

The present invention is not limited to the embodiment described above and may include other configurations and such which can achieve the object of present invention, and variations and modifications as described below are also included in the present invention.

In the embodiment described above, the sealing portion 24 is formed by placing the core wire exposed portion 13A of one end portion 11A of the electric wire 11 on the first placement portion 213, and connecting by crimp connection the pair of first core wire crimp pieces 214A, 214A to the core wire exposed portion 13A, and, in this state, providing molten resin to fill spaces between the plurality of strand 12 and curing the resin; however, the present invention is not limited to this. The sealing portion may be formed by providing molten resin to fill spaces between the plurality of strands 12 and curing the resin prior to performing the crimp connection to the core wire exposed portion 13A of the one end portion 11A of the electric wire 11, so as to prevent water from entering the distal end side (i.e., the one side). Further, in the embodiment described above, the sealing portion 24 is provided so as to include the part of the core wire exposed portion 13A that corresponds to the first intermediate portion 216 of the first terminal 21, and inside the sheath 14 of the electric wire 11 is also filled with the sealing portion 24, so as to prevent water from entering the distal end side; however, the present invention is not limited to this. The sealing portion may be arranged at an arbitrary position on the one end portion 11A of the electric wire 11 as long as the sealing portion is provided to fill spaces between the plurality of strands 12 so as to prevent water from entering the distal end side, and such arrangement of the sealing portion is still within the scope of the present invention.

Further, in the embodiment described above, the corrosion protection portion 33 is formed by placing the core wire exposed portion 13B on the second placement portion 313, connecting the pair of second core wire crimp pieces 314A, 314A to the core wire exposed portion 13B, and, in this state, applying the molten resin so as to cover the part of the second terminal 31 that corresponds to the second intermediate portion 316, the second placement portion 313, the pair of second core wire crimp pieces 314A, 314A, and the protruding portion 130B (shown in FIG. 3) of the core wire exposed portion 13B located on the distal end side with respect to the pair of second core wire crimp pieces 314A, 314A, followed by curing the resin; however, the present invention is not limited to this. Other arrangements of the corrosion protection portion is also possible, as long as the corrosion protection portion is configured such that, in a state in which the core wire exposed portion 13B is placed on the second placement portion 313 and the pair of second core wire crimp pieces 314A, 314A is connected to the core wire exposed portion 13B, the corrosion protection portion covers at least a part of the core wire exposed portion 13B that is exposed to the outside, i.e., as long as the corrosion protection portion covers the part of the second terminal 31 corresponding to the second intermediate portion 316 and the protruding portion 130B of the core wire exposed portion 13B located on the distal end side with respect to the pair of second core wire crimp pieces 314A, 314A. That is, as long as the corrosion protection portion covers, at the core wire exposed portion 13B, the part of the second terminal 31 corresponding to the second intermediate portion 316 and the protruding portion 130B of the core wire exposed portion 13B located on the distal end side with respect to the pair of second core wire crimp pieces 314A, 314A, the corrosion protection portion is within the scope of the present invention.

A preferred configuration and method and such for implementing the present invention have been described above; however, the present invention is not limited thereto. That is, although the present invention has been specifically shown and described mainly with respect to the specific embodiments, a person skilled in the art can make various modifications to those embodiments described above in terms of shape, material, number and/or other detailed configurations without departing from the scope of technical idea and an object of the present invention. Thus, the descriptions specifying shape, material and such disclosed herein are for the illustrative purpose only in order to enhance understanding of the present invention and are not intended to limit the present invention, thus the descriptions using name of a member without such limitation, either entire limitation or a part of limitation, regarding shape, material and such, are also within the present invention.

### LIST OF REFERENCE SIGNS

1 wire harness
12 plurality of strands
13 core wire
13B core wire exposed portion (exposed portion of core wire)
14 sheath
11 electric wire
11A one end portion of electric wire
11B another end portion of electric wire
21 first terminal
22 first housing
23 rubber stopper
24 sealing portion
31 second terminal
32 second housing
33 corrosion protection portion
B vehicle
B1 engine compartment
B2 vehicle interior (region other than engine compartment)

What is claimed is:

1. A wire harness to be wired in a vehicle, comprising:
an electric wire including a core wire constituted of a plurality of strands and a sheath covering the core wire;
a first terminal connected to one end portion of the electric wire, the one end portion being located on one side of the electric wire;
a first housing that accommodates the first terminal;
a second terminal connected to another end portion of the electric wire, the another end portion being located on another side of the electric wire;
a second housing that accommodates the second terminal;
a rubber stopper fitted onto the electric wire so as to close a gap between the electric wire and the first housing;
a sealing portion provided to fill spaces between the plurality of strands at the one end portion so as to prevent water from entering the one side; and
a corrosion protection portion that covers an exposed portion of the core wire in a state where the core wire and the second terminal are connected to each other at the another end portion.

2. The wire harness according to claim 1, wherein the plurality of strands constituting the electric wire includes aluminum.

3. The wire harness according to claim 1, wherein
the first terminal is configured to be connected to a first device installed in an engine compartment of the vehicle, and
the second terminal is configured to be connected to a second device installed in a region other than the engine compartment, the region being partitioned from the engine compartment.
